(19) United States
(12) Patent Application Publication
(10) Pub. No.: US 2024/0020963 A1
(43) Pub. Date: Jan. 18, 2024

(54) OBJECT EMBEDDING LEARNING

(71) Applicant: ObjectVideo Labs, LLC, Tysons, VA (US)

(72) Inventors: Gang Qian, McLean, VA (US); Sravanthi Bondugula, Vienna, VA (US); Eduardo Romera Carmena, Madrid (ES); Allison Beach, Leesburg, VA (US)

(21) Appl. No.: 18/220,330

(22) Filed: Jul. 11, 2023

Related U.S. Application Data
(60) Provisional application No. 63/388,671, filed on Jul. 13, 2022.

(51) Int. Cl. G06V 10/82; G06T 7/11; G06V 10/774; G06V 10/776; G06V 10/44; G06V 10/74

(52) U.S. Cl. CPC G06V 10/82; G06T 7/11; G06V 10/774; G06V 10/776; G06V 10/443; G06V 10/74; G06V 2201/07

(57) ABSTRACT

Methods, systems, and apparatus, including computer programs encoded on computer storage media, for Object Embedded Learning. One of the methods includes maintaining data that represents an image; providing, to a machine learning model, the data that represents the image; receiving, from the machine learning model, output data that includes i) an object detection result that indicates whether a target object is detected in the image and ii) an object embedding for the target object; and determining whether to perform an automated action using the output data.

### CROSS-REFERENCE TO RELATED APPLICATION

This application claims the benefit of U.S. Provisional Application No. 63/388,671, filed Jul. 13, 2022, the contents of which are incorporated by reference herein.

### TECHNICAL FIELD

This disclosure application relates generally to object embedding learning in the field of visual recognition.

### BACKGROUND

Visual recognition involves processing images, videos, or both, and performing visual recognition tasks, such as object classification, object detection (e.g., person, animal, vehicle, or face detection), and object segmentation (e.g., panoptic segmentation, semantic segmentation). The visual recognition tasks can be performed through a visual recognition machine learning model, e.g., a neural network model.

Neural networks are machine learning models that employ multiple layers of operations to predict one or more outputs from one or more inputs. Neural networks typically include one or more hidden layers situated between an input layer and an output layer. The output of each layer is used as input to another layer in the neural network, e.g., the next hidden layer or the output layer. An architecture of a neural network specifies what layers are included in the neural network and their properties, as well as how the neurons of each layer of the neural network are connected. In other words, the architecture specifies which layers provide their output as input to which other layers and how the output is provided.

### SUMMARY

Visual recognition involves performing visual recognition tasks, such as object classification, object detection, and object segmentation. The visual recognition tasks can be performed through a visual recognition machine learning model, e.g., a neural network model. After an object is detected in images, an object embedding, also called a feature descriptor, of the detected object may be needed for further object matching. For example, using the object embedding of a target object, the visual recognition system can associate, over time, the target object with the object detected in images for object tracking. For example, using the object embedding of a detected person or a detected vehicle, the visual recognition system can determine whether the detected person is one of multiple previously enrolled users or whether the detected vehicle is one of multiple vehicles that the video analytic system has detected previously.

An object embedding, as used in this specification, is a numeric representation of an image or an image patch that characterizes an object of interest. In general, an embedding is a numeric representation in an embedding space, e.g., an ordered collection of a fixed number of numeric values, where the number of numeric values is equal to the dimensionality of the embedding space. For example, the embedding can be a vector of floating point or other types of numeric values. Generally, the dimensionality of the embedding space is much smaller than the number of numeric values in the image represented by a given embedding.

An object embedding can be obtained by using a separate object descriptor module, e.g., using hand-crafted feature extractors or using a deep object embedding model, operating on a cropped object image that is generated using the location of the detected object in the image.

Alternatively, the object embedding can be obtained from the output of a subnetwork of a visual recognition machine learning model, e.g., a backbone subnetwork of an object detection deep neural network, according to the location of the detected object in the image. This can be a relatively computationally efficient solution because the object embedding can be obtained directly from an intermediate layer of the deep neural network. However, object embeddings from the subnetwork may lack discriminative features needed to distinguish different objects from the same object category. This is because the visual recognition machine learning model is trained to distinguish objects from different categories. For example, the object embeddings of the training examples from the same object category can be trained to be close to each other and object embeddings of the training examples from different object categories can be trained to be away from each other. Therefore, direct output from the subnetwork, e.g., a backbone subnetwork of a visual recognition neural network, may not perform well in separating objects from the same object category.

The disclosed systems, methods, and techniques relate to training a visual recognition model and using the trained model to obtain object embeddings that can be discriminative in terms of separating objects from the same object category. The visual recognition model can be a deep neural network that includes a visual recognition branch (e.g., an object detector) that generates a visual recognition result (e.g., an object detection result), and an embedding branch that generates an embedding of a detected object. The visual recognition branch and the embedding branch can share the same backbone subnetwork, e.g., can share the same initial layers. During training, the embedding branch can be trained to produce an embedding loss to guide the updates of the shared backbone subnetwork to produce enhanced object embeddings that can perform well in separating objects from the same object category. The training of the embedding branch does not require additional labels other than those already available for training the visual recognition branch. Once trained, the visual recognition network can be used in a property monitoring system to simultaneously perform object detection and embedding extraction.

In general, one innovative aspect of the subject matter described in this specification can be embodied in methods that include the actions of maintaining data that represents an image; providing, to a machine learning model, the data that represents the image; receiving, from the machine learning model, output data that includes i) an object detection result that indicates whether a target object is detected in the image and ii) an object embedding for the target object; and determining whether to perform an automated action using the output data.

In some implementations, the method includes receiving the output data from the machine learning model that comprises i) a visual recognition branch that generates the object detection result and ii) an embedding branch that generates the object embedding.

In some implementations, the method includes receiving the output data from the machine learning model that includes the embedding branch that includes a first proper subset of one or more training layers, the one or more training layers having included a) the first proper subset and b) a second proper subset that was not included in the machine learning model for inference.

In some implementations, the method includes receiving the output data from the machine learning model that includes one or more shared initial layers that generate data used by both the visual recognition branch and the embedding branch.

In some implementations, the method includes receiving the output data from the machine learning model that was trained using i) a first loss value for the one or more shared initial layers and the visual recognition branch and ii) a second loss value for the one or more shared initial layers and the embedding branch.

In some implementations, the method includes receiving the output data that includes the object embedding for the target object that was extracted from an image object embedding for the image using location data that indicates a likely location of the target object detected in the image.

In some implementations, the method includes i) an object detection result that indicates whether a target object is detected in the image and ii) an object embedding for the target object comprises:

receiving, from the machine learning model, the output data that includes i) an object detection result that indicates that a target object is detected in the image and location data that indicates a likely location of the target object detected in the image, and ii) an object embedding for the target object.

In some implementations, the method includes location data comprises a bounding box for the detected target object.

In some implementations, the method includes receiving output data that includes, for the object detection result, an object category; and receiving, for the object detection result, a likelihood that the detected target object belongs to the object category.

In some implementations, the method includes discriminative features of the detected target object, the features containing data elements for differentiating objects that belong to the same category.

In some implementations, the method includes providing, to an object matching engine, the i) object detection result that indicates whether a target object is detected in the image and ii) object embedding for the target object; receiving, from the object matching engine, data that includes an object matching result indicating whether the detected target object is likely the same as another object detected in another image from a sequence of images that includes the image as part of an object tracking process.

The subject matter described in this specification can be implemented in various embodiments and may result in one or more of the following advantages. In some implementations, by using embedding loss to guide the updates of the shared backbone subnetwork to produce enhanced object embeddings that can perform well in separating objects from the same object category, the systems and methods described in this specification can improve an accuracy of object embeddings generated by a visual recognition model that includes a visual recognition branch and an embedding branch. For instance, the object embeddings can include discriminative features needed to distinguish different objects from the same object category. In some implementations, a system that uses a visual recognition model with a visual recognition branch and an embedding branch, the latter of which was trained using labels from the visual recognition branch and does not include an embedding head, can generate more accurate object embeddings, can generate object embeddings more efficiently, or both. For example, the visual recognition model can generate object embeddings more efficiently because the embedding branch can use data from the visual recognition branch without regenerating that data on its own, saving computational resources. In some implementations, the systems and methods described in this specification can extract high quality object embeddings using the same backbone subnetwork shared with other main tasks, e.g., object detection tasks, with minimal computation overhead at the inference time. In some implementations, the systems and methods described in this specification can share the object embeddings with other subsystems running on other hardware, e.g., a tracking algorithm running on a CPU, saving computation resources because extracting the object embeddings by the other subsystems would be very slow, resource intensive, or both.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram illustrating an example of a training system for object embedding learning.

FIG. 2 is a diagram illustrating an example of a property monitoring system using object embedding learning.

FIG. 3 is a flow chart illustrating an example of a process for object embedding learning.

FIG. 4 is a flow chart illustrating an example of a process for training a machine learning model for object embedding learning.

FIG. 5 is a diagram illustrating an example of a property monitoring system.

Like reference numbers and designations in the various drawings indicate like elements.

### DETAILED DESCRIPTION

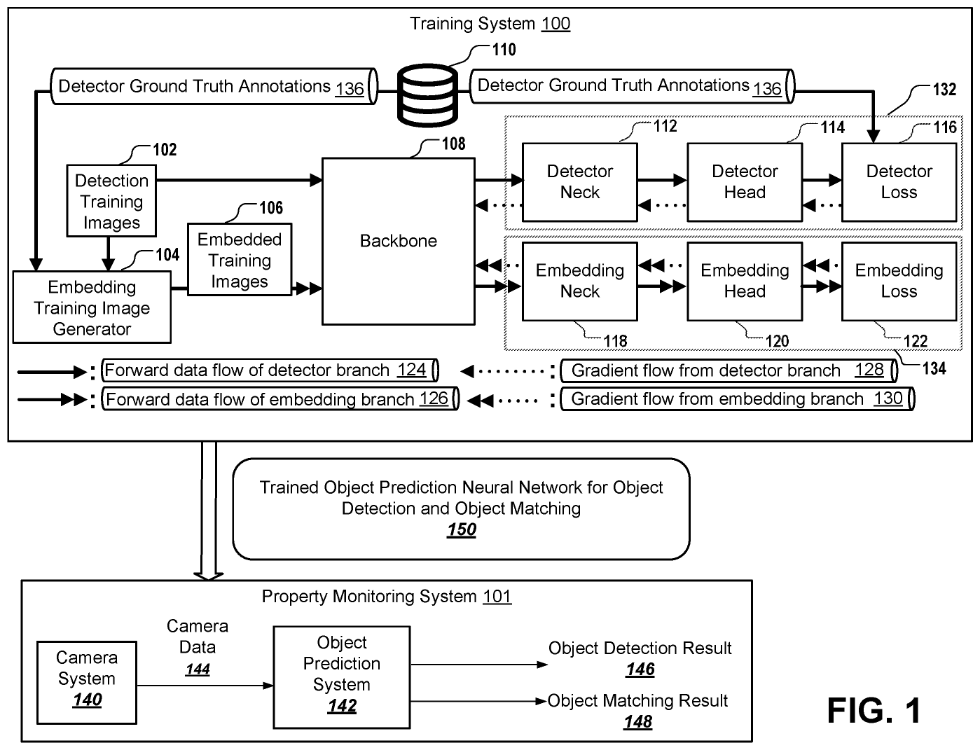

FIG. 1 is a diagram illustrating an example of a training system 100 for object embedding learning. The training system 100 can be configured to train a visual recognition model that has an embedding branch. For example, the visual recognition model can be an object prediction neural network for object detection and object matching. The following description of FIG. 1 is directed to a visual recognition model that performs an object detection task. However, the visual recognition model can be configured to perform any type of visual recognition tasks, such as object classification, object detection, object segmentation, or a combination of these.

The visual recognition model includes a visual recognition branch (e.g., a detector branch 132), an embedding branch 134, and a backbone subnetwork 108. The output of the backbone subnetwork 108 is shared by the visual recognition branch and the embedding branch 134.

The backbone subnetwork 108 can generate an initial embedding (i.e., a base feature map) of an input image. Each of the detector branch 132 and the embedding branch 134 includes a neck subnetwork and a head subnetwork. The neck subnetwork can improve the initial embedding by generating an intermediate embedding useful for the target task. The neck subnetwork can include multiple neural network blocks, and each neural network block can include multiple neural network layers. For example, the detector neck 112 can generate, from the initial embedding, an intermediate embedding useful for the object detection task, and the embedding neck 118 can generate, from the initial embedding, another intermediate embedding useful for the object matching task. The head subnetwork can generate the final predictions needed for loss computation. The head subnetwork can have fewer parameters, fewer blocks, or both, than the neck subnetwork.

An object prediction neural network architecture includes the backbone subnetwork 108, and a detector branch 132. The detector branch 132 can include a detector neck subnetwork 112, a detector head subnetwork 114, and a detector loss module 116. The object prediction neural network includes a plurality of neural network layers, e.g., convolutional layers, pooling layers, fully-connected layers, or a combination of these, which can be defined by a plurality of model parameters. The object prediction neural network can receive detector training images 102 and can generate an object detection result for each detector training image 102 through a forward data flow 124 of the detector branch. The detector branch 132 can compute a value of a detector loss function by comparing the object detection result with ground truth annotations 136. The model parameters values of the object detection neural network can be updated using the value of the detector loss function through a gradient flow 128 from the detector branch.

The backbone subnetwork 108 can be a feature extractor neural network that receives an input image and extracts an initial embedding (or an initial feature map) of the input image, and the initial embedding is provided to other parts of the visual recognition neural network (e.g., the detector branch 132) to generate a final visual recognition result (e.g., an object detection result). The initial embedding can be provided to the embedding branch 134 to generate an object embedding. The backbone subnetwork 108 can include a plurality of feature extraction layers, including convolutional layers, pool layers (e.g., a max pooling layer or an average pooling layer), and deconvolutional layers.

In some implementations, the backbone subnetwork 108 can include a portion of a deep neural network for a classification task. For example, the backbone subnetwork 108 can include a backbone of an AlexNet, VGGNet, or ResNet. In some implementations, the backbone subnetwork 108 can include a portion of a deep neural network for an object detection task. For example, the backbone subnetwork 108 can include a backbone of YOLO, Faster R-CNN, MobileNet, or Visional Transformer.

The detector neck subnetwork 112 can receive the initial embedding generated by the backbone subnetwork 108 as input and can generate an intermediate embedding that can be used to perform the object detection task, e.g., to distinguish objects that belong to different object categories. The detector neck 112 can include a plurality of convolutional layers, pooling layers, deconvolutional layers, fully-connected layers, or a combination of these.

The detector head subnetwork 114 can receive the intermediate embedding as input, and can generate an object detection result. The object detection result can include an object category output of a detected object in the training image, e.g., a respective likelihood score for each of a plurality of possible object categories, and an object bounding box that defines the location of the detected object in the training image. The detector head subnetwork 114 can include a plurality of fully-connected layers, a plurality of regressions layers, or both.

For example, a feature pyramid network is an object prediction neural network that has a ResNet backbone subnetwork 108. The bottom-up pathway, top-down pathway, and the lateral connections can be the detector neck subnetwork 112. The layers that generate the final object detection result can be the detector head subnetwork 114.

The detector loss module 116 receives the object detection result for each training image as input, and obtains ground truth annotation 136 for each training image. The ground truth annotation 136 can include object category (e.g., person, animal, vehicle, face) and object location data (e.g., a bounding box) for one or more labeled objects in each training image. The ground truth annotations 136 can be stored in a database 110. For each batch of training images 102, the detector loss module 116 computes a value of a detector loss function by comparing the object detection results with ground truth annotations 136. The training system 100 generates, using the value of the detector loss function, the updated model parameter values of the object detection neural network using appropriate updating techniques, e.g., stochastic gradient descent with backpropagation through the gradient flow 128 from detector branch. Thus, the model parameters of the backbone subnetwork 108, the model parameters of the detector neck 112, and the model parameters of the detector head 114 can be updated during training.

An embedding neural network architecture includes the backbone subnetwork 108 that is shared with the object prediction neural network, and an embedding branch 134. The embedding branch 134 can include an embedding neck subnetwork 118, an embedding head subnetwork 120, and an embedding loss module 122. Each of the embedding neck 118 and head 120 can include a plurality of neural network layers, e.g., convolutional layers, pooling layers, fully-connected layers, or a combination of these, which can be defined by a plurality of model parameters.

The embedding neural network architecture can receive embedding training images 106, or data representing the embedding training images 106, and can generate an embedding for each embedding training image through a forward data flow 126 of the embedding branch. The embedding loss module 122 can compute a value of an embedding loss function using the generated embeddings for the embedding training images 106. The model parameter values of the embedding neural network can be updated using the value of the embedding loss function through a gradient flow 130 from the embedding branch. During training, the embedding neural network can be trained to generate an object embedding that includes data that distinguishes objects of the same category.

The system includes an embedding training image generator 104 that generates the embedding training images 106 from the detector training images 102. The embedding training image generator 104 receives as inputs the detector training images 102 and the ground truth annotations 136 for the training images 102. The embedding training image generator 104 can generate an embedding training image 106 from a detector training image 102 using the location information of an object (e.g., a bounding box of an object) in the ground truth annotation 136. The embedding training image generator 104 can generate a set of object image patches from a batch of detector training images 102, and the set of cropped object image patches can be a batch of embedding training images 106.

The embedding training images 106 can be used to train the embedding neural network. In some implementations, the set of the cropped object image patches (i.e., the embedding training images 106) can depict the same object (e.g., the same person or the same vehicle) in a scene. For example, the system can generate the set of image patches by adjusting the color, hue, saturation, noise level, or a combination of these, of a training image. Thus, when training the embedding neural network using the batch of image patches (e.g., a batch of 64 image patches), the system can update the values of the parameters of the embedding neural network such that embeddings of the batch of image patches are close to each other in an embedding space defined by the embedding neural network. In some implementations, the batch of embedding training images 106 can include image patches of different objects included in the detector training images 102. The embedding training image generator 104 can generate a number of augmented images for each image patch in the batch of embedding training images 106. The augmented images and the original image patch can share the same object identification number. The training system 100 can use the object identification numbers of the image patches to compute the embedding loss 122 from the embedding branch.

For example, a detector training image 102 of size 512×512 can depict a person in a scene. The ground truth annotation can include a bounding box that indicates the location of the person in the image and a class label that indicates that the object belongs to a class category of a person. The embedding training image generator 104 can obtain the detector training image 102 and the ground truth annotation 136. The embedding training image generator 104 can generate a set of image patches for each object included in the training image, e.g., 10 image patches, using the bounding box of the person. Each additional image patch generated can have the same size, e.g., 10×10 pixels, or different sizes. For example, the embedding training image generator 104 can perform random cropping, such as randomly changing the size, the shift, the flip, the rotation, or a combination of these, of the cropped image, as long as the set of image patches depicts the same person. Thus, when training the embedding neural network using the batch of image patches, the system can update the values of the parameters of the embedding neural network such that embeddings of the batch of image patches are close to each other in an embedding space defined by the embedding neural network because the batch of image patches depicts the same person.

The embedding training images 106 are processed by the backbone subnetwork 108 that is shared with the object prediction neural network. For each image patch in the embedding training images 106, the backbone subnetwork 108 can generate an initial embedding of the embedding training image 106. The embedding neck subnetwork 118 receives the initial embedding of the embedding training image 106 and generates an object embedding for the object depicted in the embedding training image 106. The embedding neck 118 can include a plurality of convolutional layers, pooling layers, deconvolutional layers, and fully-connected layers. The object embedding can include features of the object in the embedding training image 106. For example, the object embedding can be a vector of length 128. As another example, the object embedding can be a two-dimensional feature map of size 128×128. As yet another example, the object embedding can be a three-dimensional feature map of size 64×64×128. The object embedding generated from the embedding neck subnetwork 118 can be the final output from the embedding branch at inference time, and can be used to perform object matching tasks at inference time.

The embedding head subnetwork 120 can receive the object embedding of the embedding training image 106 as input, and can generate an intermediate representation of the object embedding that can be used for loss computation. Thus, the embedding head subnetwork 120 might only be used during the training of the visual recognition model, and not used during the inference of the visual recognition model. The embedding head subnetwork 120 can include a plurality of convolutional layers, pooling layers, deconvolutional layers, fully-connected layers, or a combination of these. For example, the embedding head subnetwork 120 can receive as input an object embedding that is a vector of length 128, and can generate an intermediate representation of the object embedding. The intermediate representation can be a vector of length 3000, and can be used for loss computation.

The embedding loss module 122 receives the intermediate representations of the object embeddings of a batch of embedding training images 106 as input, and computes a value of an embedding loss function. The embedding loss function can measure a difference between the object embeddings of the batch of embedding training images 106. Examples of embedding loss function include contrastive loss, and clustering-based loss. The system generates, using the value of the embedding loss function, updated model parameter values of the embedding neural network using appropriate updating techniques, e.g., stochastic gradient descent with backpropagation through the gradient flow 130 from the embedding branch. Thus, the model parameters of the backbone subnetwork 108, the model parameters of the embedding neck 118, and the model parameters of the embedding head 120 can be updated during training.

The model parameters of the shared backbone subnetwork 108 can be updated through both the gradient flow 128 from the detector branch 132 and the gradient flow 130 from the embedding branch 134. The training system 100 can compute the forward data flow 124 for the detector branch 132 and can compute the forward data flow 126 for the embedding branch 134. The training system 100 can determine the detector loss 116 and the embedding loss 122. The training system 100 can determine a gradient for the detector branch 132 using the detector loss 116, and can determine a gradient for the embedding branch 134 using the embedding loss 122. The total gradient for the shared backbone subnetwork 108 can be a combination (e.g., summation, or weighted summation) of the gradients from both the detector branch 132 and the embedding branch 134. The training system can update the backbone subnetwork 108 using the combination of the gradients. The training system 100 can update the portions of the branches that are not shared using only the respective gradient. For example, the training system 100 can update the detector neck 112 and the detector head 114 using the gradient for the detector branch 132, and the training system 100 can update the embedding neck 118 and the embedding head 120 using the gradient for the embedding branch 134. Thus, the detector branch 132 can be trained to detect objects of interest, and during the same training process, the embedding branch 134 can be trained to extract strong object embeddings needed for object matching.

In some implementations, the embedding neural network can be trained using a self-supervised embedding learning method that does not require additional human-generated labels for computing the embedding loss for model training. An example of the self-supervised embedding learning method is swapping assignments between multiple views (SwAV). The ground truth annotations 136 for the detector training images 102 can be used to generate the embedding training images 106 and the labels for the embedding training images 106. Thus, the training of the embedding neural network does not require additional human-generated labels for the embedding training images 106 and computing the embedding loss 122 for the model training.

After the visual recognition model is trained, the training system 100 can provide the trained visual recognition model to a property monitoring system 101. The property monitoring system 101 can receive sensor data from one or more sensors at or near a property that is being monitored by the property monitoring system 101. For example, the property monitoring system can include a camera system 140 and can obtain camera data 144, e.g., images or videos of a single-family house, from the camera system 140. The property can be a residential property or a commercial property.

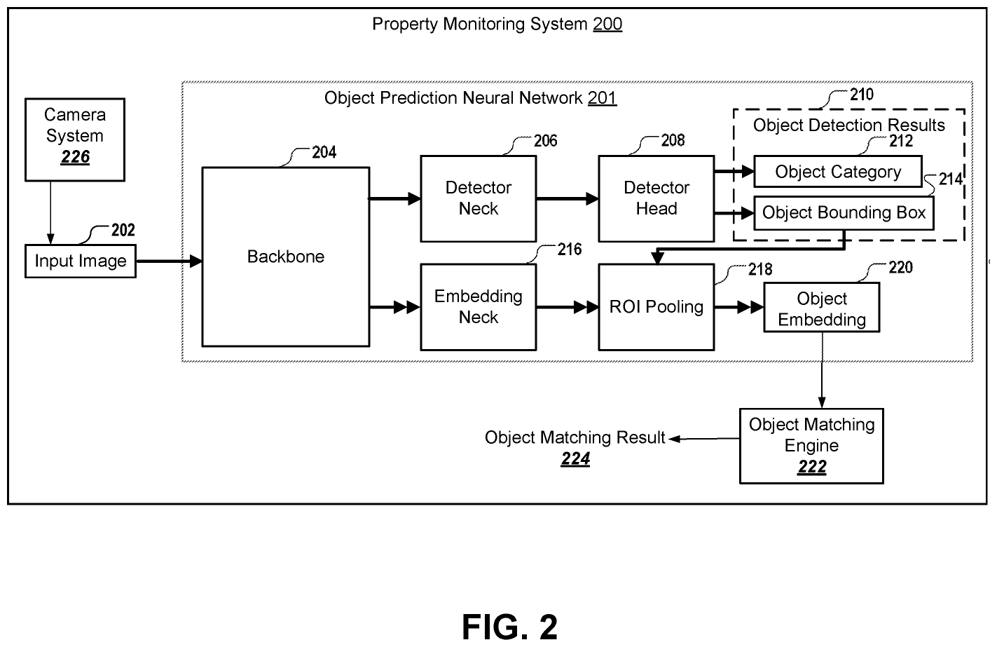

The property monitoring system 101 can perform visual recognition tasks using the sensor data, such as performing object classification, object detection, and object segmentation. The property monitoring system 101 can use the results of the visual recognition tasks to monitor the property. Details of property monitoring using a trained visual recognition model will be described below in connection with FIG. 2.

For example, the training system 100 can provide a trained object prediction neural network 150 to the property monitoring system 101. The trained object prediction neural network 150 can perform object detection and can generate object embeddings that can be used in object matching. The property monitoring system 101 can use the trained object prediction neural network 150 in an object prediction system 142. The object prediction system 142 can receive camera data 144 as input and can use the trained object prediction neural network 150 to generate an object detection result 146 and an object matching result 148 from the camera data 144.

In some examples, the training system 100 removes the embedding head 120, the embedding loss 122, or both, from the embedding neural network architecture before providing the trained object prediction neural network 150 to the property monitoring system 101. For instance, because the embedding head 120, the embedding loss 122, or both, are only used to train the embedding neural network architecture, the training system 100 can remove one or both from the embedding neural network architecture before providing the trained object prediction neural network 150 to the property monitoring system 101.

FIG. 2 is a diagram illustrating an example of a property monitoring system 200 using object embedding learning. Once a visual recognition model has been trained, it can be provided to the property monitoring system 200 and can be used for simultaneous visual recognition and embedding extraction. The following description of FIG. 2 is directed to a visual recognition model, e.g., an object prediction neural network 201, that performs an object detection task during the inference of the model. However, the visual recognition model can be configured to perform any type of visual recognition tasks, such as object classification, object detection, object segmentation, or a combination of these.

The property monitoring system 200 can include a camera system 226 that can generate camera data, e.g., an input image 202. The input image 202 can be a color image, grayscale image, or both. The input image 202 can depict a scene inside or around a property that is being monitored by the camera system 226. For example, a front door camera can capture an image near the front door of a residence, and the image can include a person who is near the front door. A driveway camera can capture an image near the driveway of a house, and the image can include a vehicle that is parked on the driveway.

The property monitoring system 200 can provide the input image 202 to an object prediction neural network 201. For example, the property monitoring system 200 can provide the input image 202 to an object prediction system 142 depicted in FIG. 1, and the object prediction system 142 can include the object prediction neural network 201 that can process the input image 202.

The object prediction neural network 201 is a neural network model, e.g., a deep neural network model, that has been trained to perform object prediction tasks, e.g., simultaneously performing object detection and embedding extraction. The object prediction neural network 201 can be previously trained using the techniques described in FIG. 1. A training system, e.g., the training system 100 of FIG. 1, can provide the trained object prediction neural network 201 to the property monitoring system 200. The property monitoring system 200 can receive the trained object prediction neural network 201 from the training system.

The object prediction neural network 201 can have a neural network architecture similar to the visual recognition model described in FIG. 1. The object prediction neural network 201 includes a backbone subnetwork 204 that can be configured to generate an initial embedding of the input image 202. The initial embedding is further processed by both the detector neck subnetwork 206 and the embedding neck subnetwork 216. The detector neck subnetwork 206 can receive the initial embedding generated by the backbone subnetwork 204 as input and can generate an intermediate embedding that can be used to perform the object detection task, e.g., to distinguish objects that belong to different object categories.

The detector head subnetwork 208 can receive the intermediate embedding as input, and can generate an object detection result 210 of the input image 202. The object detection result 210 can include information of an object detected in the input image 202, e.g., including object category 212 and object bounding box 214. In some implementations, the object detection result 210 can include information of each of two or more objects detected in the input image 202, including object category 212 and object bounding box 214 of each detected object.

The initial embedding generated from the backbone subnetwork 204 is an input to an embedding neck subnetwork 216. Because, during inference, a location of an object in the input image 202 is unknown, rather than processing an image patch that includes the object, the backbone subnetwork 204 processes the entire input image 202 and generates an initial embedding of the entire input image 202. The initial embedding generated from the backbone 204 can be provided to both the detector neck subnetwork 206 and the embedding neck subnetwork 216. That is, the system 200 only generates the initial embedding once and it is shared by the detector neck subnetwork 206 and the embedding neck subnetwork 216.

The embedding neck subnetwork 216 can receive the initial embedding generated by the backbone subnetwork 204 as input and can generate an intermediate embedding that can be used to generate an object embedding 220. Thus, the intermediate embedding generated from the embedding neck subnetwork 216 is an intermediate embedding of the entire input image 202. The embedding head subnetwork 120 is not included during the inference of the object prediction neural network 201 because it is not needed for the computation of the object embedding 220.

The object prediction neural network 201 can include a region-of-interest (ROI) block 218. The ROI block 218 can be a ROI pooling layer 218 that can be configured to generate an object embedding 220 from the intermediate embedding generated by the embedding neck 216. In some implementations, the system can use ROI align to improve the accuracy of the final embedding. In general, an ROI pooling layer can extract an ROI embedding (e.g., a feature map) for an input ROI from an image embedding of an image that includes the ROI. Each input ROI can include location information, e.g., a bounding box, of an object of interest in the image.

Here, the ROI pooling layer 218 can receive the intermediate embedding and an object bounding box 214 of a detected object as input, and can generate an object embedding 220 of the detected object. The object embedding 220 can be extracted from the intermediate embedding of the input image 202 using object bounding box 214 of a detected object in the input image 202. Because the object detector branch generates an estimated location of the detected object, e.g., the object bounding box 214, the embedding branch can use the estimated location to generate a corresponding object embedding of the detected object.

The ROI pooling layer can be implemented with any kind of pooling operations, such as max pooling, average pooling, or a combination of both. The ROI pooling layer can have a predetermined parameter that sets the size of the object embedding. For example, the ROI pooling layer can have a predetermined parameter that sets the size of the object embedding 220 to be a feature map of size 7×7, or a vector of size 128.

The object embedding 220 can be used to perform one or more object matching tasks, e.g., to distinguish objects that belong to different object categories. An object matching engine 222 can receive the object embedding 220 as an input and can generate an object matching result 224. The object matching engine 222 can determine whether the detected object matches an object that is previously detected or registered by the property monitoring system 200. In some implementations, the object matching engine 222 can determine whether the detected object is the same object, e.g., a resident, or a resident owned vehicle, that has been previously enrolled or registered by the property monitoring system. In some implementations, the object matching engine 222 can perform a tracking of a detected object, e.g., tracking a trajectory of a person near the property in response to determining whether a detected person is the same person detected in a previous frame of a video.

For example, the object prediction neural network 201 can generate an object detection result 210 indicating the object category 212 and the object bounding box 214 of a vehicle detected in a driveway image 202 captured by a driveway camera of the camera system 226. The object prediction neural network 201 can generate an object embedding 220 of the detected vehicle. The object matching engine 222 can obtain information of a registered vehicle that has been previously registered by an owner of the property that the property monitoring system 200 is currently monitoring. The information of the registered vehicle can include one or more images of the registered vehicle, an embedding of the registered vehicle that is generated by the embedding neural network (e.g., including the backbone subnetwork 204 and the embedding neck subnetwork 216), or both. The information of the registered vehicle can be stored in a database. The object matching engine 222 can compare the object embedding 220 of the detected vehicle and the embedding of the registered vehicle in an embedding space of the embedding neural network.

For example, the object matching engine 222 can compute a distance between the two embeddings. If the distance is smaller than a threshold value, the object matching engine 222 can generate an object matching result 224 indicating that the detected vehicle is likely the registered vehicle. If the distance is larger than the threshold value, the object matching engine 222 can generate an object matching result 224 indicating that the detected vehicle is likely not the registered vehicle. After receiving the object matching result 224, the property monitoring system 200 can send a notification to a user device, e.g., notifying a property owner of the unknown vehicle parked on the driveway of the property.

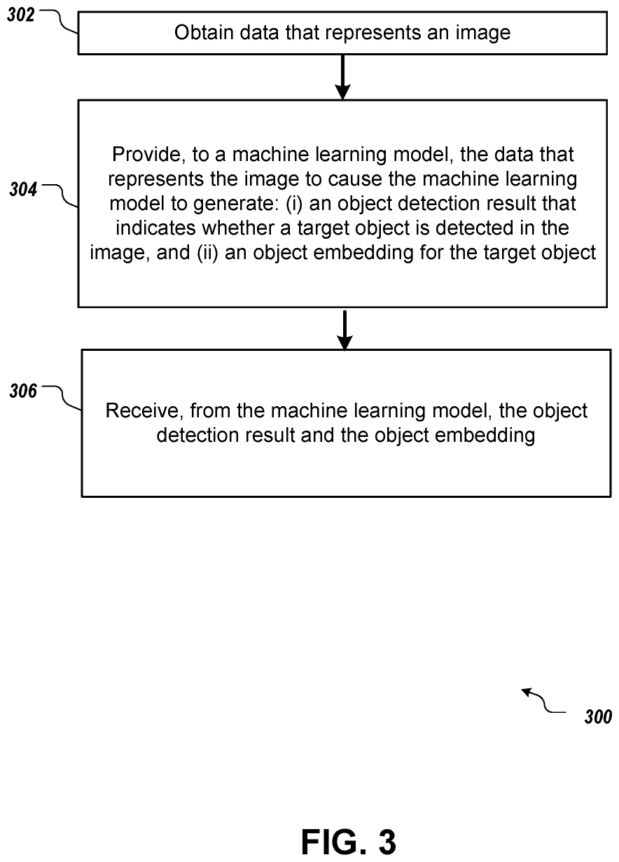

FIG. 3 is a flow chart illustrating an example of a process 300 for object embedding learning. The process 300 can be performed by one or more computer systems, for example, the property monitoring system 200 of FIG. 2. In some implementations, some or all of the process 300 can be performed by the property monitoring system 200, or by another computer system located at another location.

The system obtains data that represents an image (302). The data can be sensor data captured by a sensor of a property monitoring system. For example, the data can include an image or a video captured by a camera system of a property monitoring system. For example, as shown in FIG. 2, the data can be the input image 202 obtained from a camera system 226.

The system provides, to a machine learning model, the data that represents the image to cause the machine learning model to generate: (i) an object detection result that indicates whether a target object is detected in the image, and (ii) an object embedding for the target object (304). The machine learning model can be a visual recognition model that has been trained to simultaneously perform visual recognition tasks and embedding extractions. For example, the machine learning model can be the object prediction model 201 that has been trained to simultaneously generate an object detection result 210 and generate an object embedding 220 for the detected object.

The machine learning model can include a backbone subnetwork that receives the data as input, processes the data, and provides an initial embedding of the data to both an object prediction neural network and an object embedding neural network. The object prediction neural network determines a likely location of the target object detected in the image and provides data indicating the likely location to the object embedding neural network. The object embedding neural network determines the object embedding for the target object using the initial embedding from the backbone subnetwork and the likely location for the target object.

The object embedding neural network can use the likely location for the target object in various ways. For example, the system can use the predicted object location after the backbone subnetwork 204 and before the embedding neck subnetwork 216, or after the embedding neck subnetwork 216 of the object embedding neural network.

In some implementations, the system can use the predicted object location, e.g., the object bounding box 214, after the embedding neck 216. The system can reuse the initial embedding generated by the backbone 204 as an input to the embedding neck 216. The embedding neck 216 can take the initial embedding as input and can generate an intermediate embedding for the detected object from the initial embedding. Because the initial embedding is an embedding generated from the entire input image 202, the intermediate embedding is also an embedding corresponding to the entire input image 202. The system can include an ROI pooling layer 218 after the embedding neck subnetwork 216. The ROI pooling layer 218 can generate an object embedding 220 from the intermediate embedding by extracting a ROI feature map according to the predicted object location of the target object. Note that this implementation matches the inference flow depicted in FIG. 2.

In some implementations, the system can use the predicted object location, e.g., the object bounding box 214, after the backbone subnetwork 204 and before the embedding neck subnetwork 216. Rather than processing the initial embedding of the entire input image 202 using the embedding neck 216, the system can include an ROI pooling layer after the backbone subnetwork 204 and before the embedding neck 216. The ROI pooling layer can obtain an intermediate embedding from the initial embedding by extracting a ROI feature map according to the predicted object location. The embedding neck 216 can take the intermediate embedding as input and can generate an object embedding for the detected target object from the intermediate embedding. Because the intermediate embedding can have a smaller size than the initial embedding, compared with the inference flow depicted in FIG. 2, the computation of the embedding neck 216 can be reduced.

The system receives, from the machine learning model, the object detection result and the object embedding (306). The system can receive an object detection result that can include an object category and a bounding box of the detected object. The system can receive an object embedding of the detected object and the object embedding can include discriminative features of the detected object that can be used to differentiate objects that belong to the same category. For example, the system can provide the object embedding 220 to an object matching engine 222, and the object matching engine 222 can generate an object matching result 224 using the object embedding 220 of the detected object. The object matching result 224 can indicate whether the detected object matches one or more other objects, e.g., one or more other objects that belong to the same object category 212 of the detected object. For example, the object matching result 224 can indicate whether a detected person is a resident of the property that is being monitored.

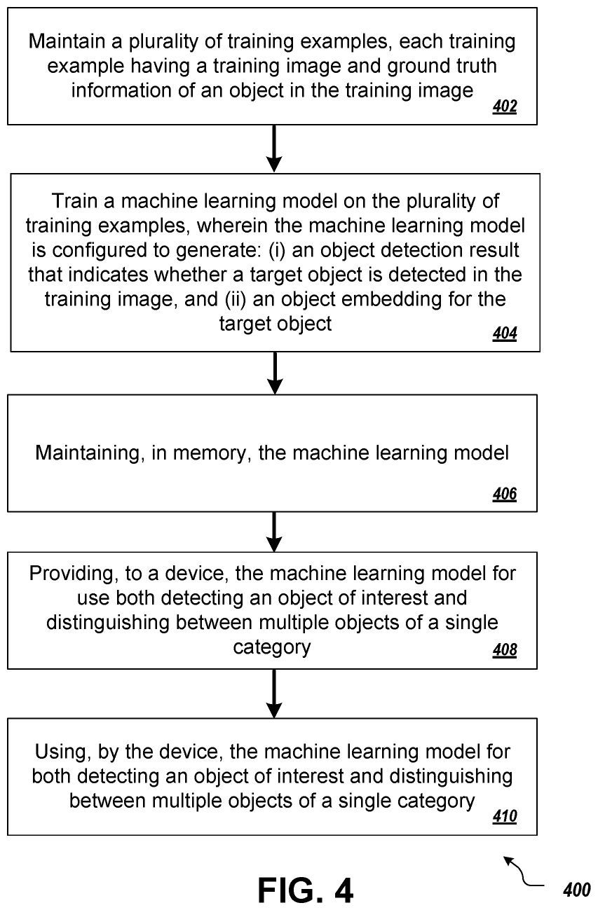

FIG. 4 is a flow chart illustrating an example of a process 400 for training a machine learning model for object embedding learning. The process 400 can be performed by one or more computer systems, for example, the training system 100 of FIG. 1. In some implementations, some or all of the process 400 can be performed by the training system 100, or by another computer system located at another location.

The system maintains a plurality of training examples (402). Each training example has a training image and ground truth information of an object in the training image. The training image can be generated from sensor data obtained by a sensor of a property monitoring system. The training image can depict a scene near or inside a property that is being monitored. The property monitoring system can obtain historical sensor data obtained by one or more sensors of the system over a period of time. The property monitoring system can store the sensor data in a training database. The training system can obtain the training examples from the training database.

The ground truth information of the object in the training image can include a ground truth object category and a ground object location, e.g., a ground truth bounding box of the object. The ground truth information of the object in the training image can be obtained manually, automatically, or a combination of both. For example, a human labeler can manually label the ground truth object category and the ground truth object bounding box. For example, an automatic program can generate initial ground truth labels and a human labeler can review the initial ground truth labels as needed to determine the final ground truth labels for the training images.

In some implementations, the system can generate embedding training images from the plurality of training examples. For example, the system can generate embedding training images 106 from the detector training images 102 and the detector ground truth annotations 136. The embedding training images can be image patches cropped from the detector training images. The embedding training images can be used to train an embedding branch of the machine learning model.

The system trains a machine learning model on the plurality of training examples (404). The machine learning model is configured to generate: (i) an object detection result that indicates whether a target object is detected in the training image, and (ii) an object embedding for the target object. The object detection result can include a likelihood score for each possible category that the detected object belongs to and a predicted bounding box of the detected object. The object embedding can include a feature map generated by an embedding neck subnetwork 118 of the embedding branch 134.

The machine learning model can include a backbone subnetwork that receives the data as input, processes the data, and provides an initial embedding to both an object prediction neural network and an object embedding neural network. The object prediction neural network determines a likely location of an object detected in the image. The object embedding neural network determines the object embedding for the object using the ground truth location for the object.

The object embedding neural network can use the ground truth object location in various ways for the training of the machine learning model. For example, the system can use the ground truth object location before the backbone 108, after the backbone 108 and before the embedding neck 118, or after the embedding neck 118 of the object embedding neural network.

The system maintains in memory the machine learning model (406). In this way, the system can store one or more different machine learning models. In some instances, the model can then be reused for inference, retraining, or both. In some instances, the maintained machine learning models can be exchanged between various systems to decrease the amount of training time needed for a new system. In some instances the maintained machine learning models are stored in a location remote to the machine learning system or the device.

The system provides to a device the machine learning model for use both detecting an object of interest and distinguishing between multiple objects of a single category (408). The system can choose a required trained machine learning models to different devices using the device type, location, or both. The system can utilize input to determine appropriate machine learning models for one or more devices.

The device can use the machine learning model for both detecting an object of interest and distinguish between multiple objects of a single category (410). In this way, the device can then employ the trained machine learning model in order to efficiently detect and distinguish between objects. For instance, a device such as a camera can utilize the trained machine learning model to more quickly and efficiently identify

In some implementations, the system can use the ground truth object location before the backbone 108. In particular, the system can generate embedding training images from the training images using the ground truth object locations of objects in the training images. The backbone subnetwork can process an embedding training image that is generated from the training image, e.g., a patch of the training image cropped using a ground truth bounding box of an object in the training image, to generate an initial embedding for the embedding training image. The machine learning model can include an embedding branch that can generate an object embedding for the target object from the initial embedding for the embedding training image.

In some implementations, the system can use the ground truth object location after the backbone 108 and before the embedding neck 118. Rather than generating the embedding training images and processing the embedding training images using the backbone subnetwork, the system can reuse the initial embedding for the training image as an input to the embedding branch 134. The system can include an ROI pooling layer after the backbone subnetwork 108 and before the embedding neck 118. The ROI pooling layer can obtain an intermediate embedding from the initial embedding by extracting a ROI feature map according to the ground truth object location. The embedding neck 118 can take the intermediate embedding as input and can generate an object embedding for the target object from the intermediate embedding.

In some implementations, the system can use the ground truth object location after the embedding neck 118. Rather than generating the embedding training images or including an ROI pooling layer after the backbone subnetwork 108, the system can reuse the initial embedding for the training image as an input to the embedding branch 134. The embedding neck 118 can take the initial embedding as input and can generate an intermediate embedding for the target object from the initial embedding. Because the initial embedding is an embedding generated from the entire training image, the intermediate embedding is also an embedding corresponding to the entire training image. The system can include an ROI pooling layer after the embedding neck subnetwork 118 and before the embedding head subnetwork 120. The ROI pooling layer can obtain an object embedding from the intermediate embedding by extracting a ROI feature map according to the ground truth object location. Note that this implementation matches the inference flow depicted in FIG. 2.

The system can compare the object detection result with the ground truth information of the object to determine a detector loss 116. The system can generate a gradient flow 128 from the detector branch 132 using the detector loss 116. The system can generate an embedding loss 122 from the object embeddings of a batch of embedding training images 106. The system can generate a gradient flow 130 from the embedding branch 134 using the embedding loss 134.

The system can update the parameters of the machine learning model using the gradient flow computed from the losses. For example, the system can update the parameters of a shared backbone subnetwork 108 using both the gradient flow 128 from the detector branch 132 and the gradient flow 130 from the embedding branch 134. The system can update the parameters of the detector branch 132 using the gradient flow 128 from the detector branch 132. The system can update the parameters of the embedding branch 134 using the gradient flow 130 from the embedding branch 134.

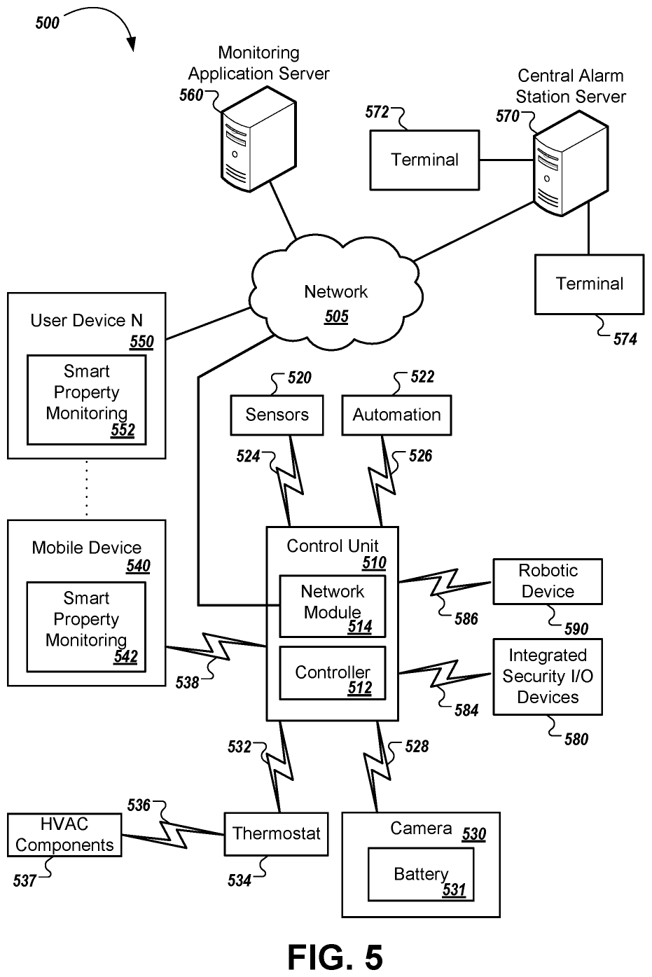

FIG. 5 is a diagram illustrating an example of a property monitoring system 500. The property monitoring system 500 includes a network 505, a control unit 510, one or more user devices 540 and 550, a monitoring application server 560, and a central alarm station server 570. In some examples, the network 505 facilitates communications between the control unit 510, the one or more user devices 540 and 550, the monitoring application server 560, and the central alarm station server 570.

The network 505 is configured to enable exchange of electronic communications between devices connected to the network 505. For example, the network 505 may be configured to enable exchange of electronic communications between the control unit 510, the one or more user devices 540 and 550, the monitoring application server 560, and the central alarm station server 570. The network 505 may include, for example, one or more of the Internet, Wide Area Networks (WANs), Local Area Networks (LANs), analog or digital wired and wireless telephone networks (e.g., a public switched telephone network (PSTN), Integrated Services Digital Network (ISDN), a cellular network, and Digital Subscriber Line (DSL)), radio, television, cable, satellite, or any other delivery or tunneling mechanism for carrying data. Network 505 may include multiple networks or subnetworks, each of which may include, for example, a wired or wireless data pathway. The network 505 may include a circuit-switched network, a packet-switched data network, or any other network able to carry electronic communications (e.g., data or voice communications). For example, the network 505 may include networks based on the Internet protocol (IP), asynchronous transfer mode (ATM), the PSTN, packet-switched networks based on IP, X.25, or Frame Relay, or other comparable technologies and may support voice using, for example, VoIP, or other comparable protocols used for voice communications. The network 505 may include one or more networks that include wireless data channels and wireless voice channels. The network 505 may be a wireless network, a broadband network, or a combination of networks including a wireless network and a broadband network.

The control unit 510 includes a controller 512 and a network module 514. The controller 512 is configured to control a control unit monitoring system (e.g., a control unit system) that includes the control unit 510. In some examples, the controller 512 may include a processor or other control circuitry configured to execute instructions of a program that controls operation of a control unit system. In these examples, the controller 512 may be configured to receive input from sensors, flow meters, or other devices included in the control unit system and control operations of devices included in the household (e.g., speakers, lights, doors, etc.). For example, the controller 512 may be configured to control operation of the network module 514 included in the control unit 510.

The network module 514 is a communication device configured to exchange communications over the network 505. The network module 514 may be a wireless communication module configured to exchange wireless communications over the network 505. For example, the network module 514 may be a wireless communication device configured to exchange communications over a wireless data channel and a wireless voice channel. In this example, the network module 514 may transmit alarm data over a wireless data channel and establish a two-way voice communication session over a wireless voice channel. The wireless communication device may include one or more of a LTE module, a GSM module, a radio modem, a cellular transmission module, or any type of module configured to exchange communications in one of the following formats: LTE, GSM or GPRS, CDMA, EDGE or EGPRS, EV-DO or EVDO, UMTS, or IP.

The network module 514 also may be a wired communication module configured to exchange communications over the network 505 using a wired connection. For instance, the network module 514 may be a modem, a network interface card, or another type of network interface device. The network module 514 may be an Ethernet network card configured to enable the control unit 510 to communicate over a local area network and/or the Internet. The network module 514 also may be a voice band modem configured to enable the alarm panel to communicate over the telephone lines of Plain Old Telephone Systems (POTS).

The control unit system that includes the control unit 510 includes one or more sensors. For example, the monitoring system 500 may include multiple sensors 520. The sensors 520 may include a lock sensor, a contact sensor, a motion sensor, or any other type of sensor included in a control unit system. The sensors 520 also may include an environmental sensor, such as a temperature sensor, a water sensor, a rain sensor, a wind sensor, a light sensor, a smoke detector, a carbon monoxide detector, an air quality sensor, etc. The sensors 520 further may include a health monitoring sensor, such as a prescription bottle sensor that monitors taking of prescriptions, a blood pressure sensor, a blood sugar sensor, a bed mat configured to sense presence of liquid (e.g., bodily fluids) on the bed mat, etc. In some examples, the health monitoring sensor can be a wearable sensor that attaches to a user in the property. The health monitoring sensor can collect various health data, including pulse, heart-rate, respiration rate, sugar or glucose level, bodily temperature, or motion data. The sensors 520 can include a radio-frequency identification (RFID) sensor that identifies a particular article that includes a pre-assigned RFID tag.

The control unit 510 communicates with the module 522 and a camera 530 to perform monitoring. The module 522 is connected to one or more devices that enable property automation, e.g., home or business automation. For instance, the module 522 may be connected to one or more lighting systems and may be configured to control operation of the one or more lighting systems. Also, the module 522 may be connected to one or more electronic locks at the property and may be configured to control operation of the one or more electronic locks (e.g., control Z-Wave locks using wireless communications in the Z-Wave protocol). Further, the module 522 may be connected to one or more appliances at the property and may be configured to control operation of the one or more appliances. The module 522 may include multiple modules that are each specific to the type of device being controlled in an automated manner. The module 522 may control the one or more devices based on commands received from the control unit 510. For instance, the module 522 may cause a lighting system to illuminate an area to provide a better image of the area when captured by a camera 530. The camera 530 can include one or more batteries 531 that require charging.

A drone 590 can be used to survey the electronic system 500. In particular, the drone 590 can capture images of each item found in the electronic system 500 and provide images to the control unit 510 for further processing. Alternatively, the drone 590 can process the images to determine an identification of the items found in the electronic system 500.

The camera 530 may be a video/photographic camera or other type of optical sensing device configured to capture images. For instance, the camera 530 may be configured to capture images of an area within a property monitored by the control unit 510. The camera 530 may be configured to capture single, static images of the area or video images of the area in which multiple images of the area are captured at a relatively high frequency (e.g., thirty images per second) or both. The camera 530 may be controlled based on commands received from the control unit 510.

The camera 530 may be triggered by several different types of techniques. For instance, a Passive Infra-Red (PIR) motion sensor may be built into the camera 530 and used to trigger the camera 530 to capture one or more images when motion is detected. The camera 530 also may include a microwave motion sensor built into the camera and used to trigger the camera 530 to capture one or more images when motion is detected. The camera 530 may have a “normally open” or “normally closed” digital input that can trigger capture of one or more images when external sensors (e.g., the sensors 520, PIR, door/window, etc.) detect motion or other events. In some implementations, the camera 530 receives a command to capture an image when external devices detect motion or another potential alarm event. The camera 530 may receive the command from the controller 512 or directly from one of the sensors 520.

In some examples, the camera 530 triggers integrated or external illuminators (e.g., Infra-Red, Z-wave controlled “white” lights, lights controlled by the module 522, etc.) to improve image quality when the scene is dark. An integrated or separate light sensor may be used to determine if illumination is desired and may result in increased image quality.

The camera 530 may be programmed with any combination of time/day schedules, system “arming state”, or other variables to determine whether images should be captured or not when triggers occur. The camera 530 may enter a low-power mode when not capturing images. In this case, the camera 530 may wake periodically to check for inbound messages from the controller 512. The camera 530 may be powered by internal, replaceable batteries, e.g., if located remotely from the control unit 510. The camera 530 may employ a small solar cell to recharge the battery when light is available. The camera 530 may be powered by the controller's 512 power supply if the camera 530 is co-located with the controller 512.

In some implementations, the camera 530 communicates directly with the monitoring application server 560 over the Internet. In these implementations, image data captured by the camera 530 does not pass through the control unit 510 and the camera 530 receives commands related to operation from the monitoring application server 560.

The system 500 also includes thermostat 534 to perform dynamic environmental control at the property. The thermostat 534 is configured to monitor temperature and/or energy consumption of an HVAC system associated with the thermostat 534, and is further configured to provide control of environmental (e.g., temperature) settings. In some implementations, the thermostat 534 can additionally or alternatively receive data relating to activity at a property and/or environmental data at a property, e.g., at various locations indoors and outdoors at the property. The thermostat 534 can directly measure energy consumption of the HVAC system associated with the thermostat, or can estimate energy consumption of the HVAC system associated with the thermostat 534, for example, based on detected usage of one or more components of the HVAC system associated with the thermostat 534. The thermostat 534 can communicate temperature and/or energy monitoring information to or from the control unit 510 and can control the environmental (e.g., temperature) settings based on commands received from the control unit 510.

In some implementations, the thermostat 534 is a dynamically programmable thermostat and can be integrated with the control unit 510. For example, the dynamically programmable thermostat 534 can include the control unit 510, e.g., as an internal component to the dynamically programmable thermostat 534. In addition, the control unit 510 can be a gateway device that communicates with the dynamically programmable thermostat 534. In some implementations, the thermostat 534 is controlled via one or more module 522.

A module 537 is connected to one or more components of an HVAC system associated with a property, and is configured to control operation of the one or more components of the HVAC system. In some implementations, the module 537 is also configured to monitor energy consumption of the HVAC system components, for example, by directly measuring the energy consumption of the HVAC system components or by estimating the energy usage of the one or more HVAC system components based on detecting usage of components of the HVAC system. The module 537 can communicate energy monitoring information and the state of the HVAC system components to the thermostat 534 and can control the one or more components of the HVAC system based on commands received from the thermostat 534.

In some examples, the system 500 further includes one or more robotic devices 590. The robotic devices 590 may be any type of robots that are capable of moving and taking actions that assist in security monitoring. For example, the robotic devices 590 may include drones that are capable of moving throughout a property based on automated control technology and/or user input control provided by a user. In this example, the drones may be able to fly, roll, walk, or otherwise move about the property. The drones may include helicopter type devices (e.g., quad copters), rolling helicopter type devices (e.g., roller copter devices that can fly and also roll along the ground, walls, or ceiling) and land vehicle type devices (e.g., automated cars that drive around a property). In some cases, the robotic devices 590 may be robotic devices 590 that are intended for other purposes and merely associated with the system 500 for use in appropriate circumstances. For instance, a robotic vacuum cleaner device may be associated with the monitoring system 500 as one of the robotic devices 590 and may be controlled to take action responsive to monitoring system events.

In some examples, the robotic devices 590 automatically navigate within a property. In these examples, the robotic devices 590 include sensors and control processors that guide movement of the robotic devices 590 within the property. For instance, the robotic devices 590 may navigate within the property using one or more cameras, one or more proximity sensors, one or more gyroscopes, one or more accelerometers, one or more magnetometers, a global positioning system (GPS) unit, an altimeter, one or more sonar or laser sensors, and/or any other types of sensors that aid in navigation about a space. The robotic devices 590 may include control processors that process output from the various sensors and control the robotic devices 590 to move along a path that reaches the desired destination and avoids obstacles. In this regard, the control processors detect walls or other obstacles in the property and guide movement of the robotic devices 590 in a manner that avoids the walls and other obstacles.

In addition, the robotic devices 590 may store data that describes attributes of the property. For instance, the robotic devices 590 may store a floorplan and/or a three-dimensional model of the property that enables the robotic devices 590 to navigate the property. During initial configuration, the robotic devices 590 may receive the data describing attributes of the property, determine a frame of reference to the data (e.g., a property or reference location in the property), and navigate the property based on the frame of reference and the data describing attributes of the property. Further, initial configuration of the robotic devices 590 also may include learning of one or more navigation patterns in which a user provides input to control the robotic devices 590 to perform a specific navigation action (e.g., fly to an upstairs bedroom and spin around while capturing video and then return to a property charging base). In this regard, the robotic devices 590 may learn and store the navigation patterns such that the robotic devices 590 may automatically repeat the specific navigation actions upon a later request.

In some examples, the robotic devices 590 may include data capture and recording devices. In these examples, the robotic devices 590 may include one or more cameras, one or more motion sensors, one or more microphones, one or more biometric data collection tools, one or more temperature sensors, one or more humidity sensors, one or more air flow sensors, and/or any other types of sensor that may be useful in capturing monitoring data related to the property and users in the property. The one or more biometric data collection tools may be configured to collect biometric samples of a person in the property with or without contact of the person. For instance, the biometric data collection tools may include a fingerprint scanner, a hair sample collection tool, a skin cell collection tool, and/or any other tool that allows the robotic devices 590 to take and store a biometric sample that can be used to identify the person (e.g., a biometric sample with DNA that can be used for DNA testing).

In some implementations, the robotic devices 590 may include output devices. In these implementations, the robotic devices 590 may include one or more displays, one or more speakers, and/or any type of output devices that allow the robotic devices 590 to communicate information to a nearby user.

The robotic devices 590 also may include a communication module that enables the robotic devices 590 to communicate with the control unit 510, each other, and/or other devices. The communication module may be a wireless communication module that allows the robotic devices 590 to communicate wirelessly. For instance, the communication module may be a Wi-Fi module that enables the robotic devices 590 to communicate over a local wireless network at the property. The communication module further may be a 900 MHz wireless communication module that enables the robotic devices 590 to communicate directly with the control unit 510. Other types of short-range wireless communication protocols, such as Bluetooth, Bluetooth LE, Z-wave, Zigbee, etc., may be used to allow the robotic devices 590 to communicate with other devices in the property. In some implementations, the robotic devices 590 may communicate with each other or with other devices of the system 500 through the network 505.

The robotic devices 590 further may include processor and storage capabilities. The robotic devices 590 may include any suitable processing devices that enable the robotic devices 590 to operate applications and perform the actions described throughout this disclosure. In addition, the robotic devices 590 may include solid-state electronic storage that enables the robotic devices 590 to store applications, configuration data, collected sensor data, and/or any other type of information available to the robotic devices 590.

The robotic devices 590 are associated with one or more charging stations. The charging stations may be located at predefined home base or reference locations in the property. The robotic devices 590 may be configured to navigate to the charging stations after completion of tasks needed to be performed for the property monitoring system 500. For instance, after completion of a monitoring operation or upon instruction by the control unit 510, the robotic devices 590 may be configured to automatically fly to and land on one of the charging stations. In this regard, the robotic devices 590 may automatically maintain a fully charged battery in a state in which the robotic devices 590 are ready for use by the property monitoring system 500.

The charging stations may be contact based charging stations and/or wireless charging stations. For contact based charging stations, the robotic devices 590 may have readily accessible points of contact that the robotic devices 590 are capable of positioning and mating with a corresponding contact on the charging station. For instance, a helicopter type robotic device may have an electronic contact on a portion of its landing gear that rests on and mates with an electronic pad of a charging station when the helicopter type robotic device lands on the charging station. The electronic contact on the robotic device may include a cover that opens to expose the electronic contact when the robotic device is charging and closes to cover and insulate the electronic contact when the robotic device is in operation.

For wireless charging stations, the robotic devices 590 may charge through a wireless exchange of power. In these cases, the robotic devices 590 need only locate themselves closely enough to the wireless charging stations for the wireless exchange of power to occur. In this regard, the positioning needed to land at a predefined home base or reference location in the property may be less precise than with a contact based charging station. Based on the robotic devices 590 landing at a wireless charging station, the wireless charging station outputs a wireless signal that the robotic devices 590 receive and convert to a power signal that charges a battery maintained on the robotic devices 590.

In some implementations, each of the robotic devices 590 has a corresponding and assigned charging station such that the number of robotic devices 590 equals the number of charging stations. In these implementations, the robotic devices 590 always navigate to the specific charging station assigned to that robotic device. For instance, a first robotic device may always use a first charging station and a second robotic device may always use a second charging station.

In some examples, the robotic devices 590 may share charging stations. For instance, the robotic devices 590 may use one or more community charging stations that are capable of charging multiple robotic devices 590. The community charging station may be configured to charge multiple robotic devices 590 in parallel. The community charging station may be configured to charge multiple robotic devices 590 in serial such that the multiple robotic devices 590 take turns charging and, when fully charged, return to a predefined home base or reference location in the property that is not associated with a charger. The number of community charging stations may be less than the number of robotic devices 590.

Also, the charging stations may not be assigned to specific robotic devices 590 and may be capable of charging any of the robotic devices 590. In this regard, the robotic devices 590 may use any suitable, unoccupied charging station when not in use. For instance, when one of the robotic devices 590 has completed an operation or is in need of battery charge, the control unit 510 references a stored table of the occupancy status of each charging station and instructs the robotic device to navigate to the nearest charging station that is unoccupied.

The system 500 further includes one or more integrated security devices 580. The one or more integrated security devices may include any type of device used to provide alerts based on received sensor data. For instance, the one or more control units 510 may provide one or more alerts to the one or more integrated security input/output devices 580. Additionally, the one or more control units 510 may receive sensor data from the sensors 520 and determine whether to provide an alert to the one or more integrated security input/output devices 580.

The sensors 520, the module 522, the camera 530, the thermostat 534, and the integrated security devices 580 may communicate with the controller 512 over communication links 524, 526, 528, 532, 538, 584, and 586. The communication links 524, 526, 528, 532, 538, 584, and 586 may be a wired or wireless data pathway configured to transmit signals from the sensors 520, the module 522, the camera 530, the thermostat 534, the drone 590, and the integrated security devices 580 to the controller 512. The sensors 520, the module 522, the camera 530, the thermostat 534, the drone 590, and the integrated security devices 580 may continuously transmit sensed values to the controller 512, periodically transmit sensed values to the controller 512, or transmit sensed values to the controller 512 in response to a change in a sensed value. In some implementations, the drone 590 can communicate with the monitoring application server 560 over network 505. The drone 590 can connect and communicate with the monitoring application server 560 using a Wi-Fi or a cellular connection.

The communication links 524, 526, 528, 532, 538, 584, and 586 may include a local network. The sensors 520, the module 522, the camera 530, the thermostat 534, the drone 590 and the integrated security devices 580, and the controller 512 may exchange data and commands over the local network. The local network may include 802.11 “Wi-Fi” wireless Ethernet (e.g., using low-power Wi-Fi chipsets), Z-Wave, Zigbee, Bluetooth, “HomePlug” or other “Powerline” networks that operate over AC wiring, and a Category 5 (CAT5) or Category 6 (CAT6) wired Ethernet network. The local network may be a mesh network constructed based on the devices connected to the mesh network.

The monitoring application server 560 is an electronic device configured to provide monitoring services by exchanging electronic communications with the control unit 510, the one or more user devices 540 and 550, and the central alarm station server 570 over the network 505. For example, the monitoring application server 560 may be configured to monitor events (e.g., alarm events) generated by the control unit 510. In this example, the monitoring application server 560 may exchange electronic communications with the network module 514 included in the control unit 510 to receive information regarding events (e.g., alerts) detected by the control unit 510. The monitoring application server 560 also may receive information regarding events (e.g., alerts) from the one or more user devices 540 and 550.

In some examples, the monitoring application server 560 may route alert data received from the network module 514 or the one or more user devices 540 and 550 to the central alarm station server 570. For example, the monitoring application server 560 may transmit the alert data to the central alarm station server 570 over the network 505.

The monitoring application server 560 may store sensor and image data received from the monitoring system 500 and perform analysis of sensor and image data received from the monitoring system 500. Based on the analysis, the monitoring application server 560 may communicate with and control aspects of the control unit 510 or the one or more user devices 540 and 550.

The monitoring application server 560 may provide various monitoring services to the system 500. For example, the monitoring application server 560 may analyze the sensor, image, and other data to determine an activity pattern of a resident of the property monitored by the system 500. In some implementations, the monitoring application server 560 may analyze the data for alarm conditions or may determine and perform actions at the property by issuing commands to one or more of the controls 522, possibly through the control unit 510.

The central alarm station server 570 is an electronic device configured to provide alarm monitoring service by exchanging communications with the control unit 510, the one or more mobile devices 540 and 550, and the monitoring application server 560 over the network 505. For example, the central alarm station server 570 may be configured to monitor alerting events generated by the control unit 510. In this example, the central alarm station server 570 may exchange communications with the network module 514 included in the control unit 510 to receive information regarding alerting events detected by the control unit 510. The central alarm station server 570 also may receive information regarding alerting events from the one or more mobile devices 540 and 550 and/or the monitoring application server 560.

The central alarm station server 570 is connected to multiple terminals 572 and 574. The terminals 572 and 574 may be used by operators to process alerting events. For example, the central alarm station server 570 may route alerting data to the terminals 572 and 574 to enable an operator to process the alerting data. The terminals 572 and 574 may include general-purpose computers (e.g., desktop personal computers, workstations, or laptop computers) that are configured to receive alerting data from a server in the central alarm station server 570 and render a display of information based on the alerting data. For instance, the controller 512 may control the network module 514 to transmit, to the central alarm station server 570, alerting data indicating that a sensor 520 detected motion from a motion sensor via the sensors 520. The central alarm station server 570 may receive the alerting data and route the alerting data to the terminal 572 for processing by an operator associated with the terminal 572. The terminal 572 may render a display to the operator that includes information associated with the alerting event (e.g., the lock sensor data, the motion sensor data, the contact sensor data, etc.) and the operator may handle the alerting event based on the displayed information.

In some implementations, the terminals 572 and 574 may be mobile devices or devices designed for a specific function. Although FIG. 5 illustrates two terminals for brevity, actual implementations may include more (and, perhaps, many more) terminals.

The one or more user devices 540 and 550 are devices that host and display user interfaces. For instance, the user device 540 is a mobile device that hosts or runs one or more native applications (e.g., the smart property application 542). The user device 540 may be a cellular phone or a non-cellular locally networked device with a display. The user device 540 may include a cell phone, a smart phone, a tablet PC, a personal digital assistant (“PDA”), or any other portable device configured to communicate over a network and display information. For example, implementations may also include Blackberry-type devices (e.g., as provided by Research in Motion), electronic organizers, iPhone-type devices (e.g., as provided by Apple), iPod devices (e.g., as provided by Apple) or other portable music players, other communication devices, and handheld or portable electronic devices for gaming, communications, and/or data organization. The user device 540 may perform functions unrelated to the monitoring system, such as placing personal telephone calls, playing music, playing video, displaying pictures, browsing the Internet, maintaining an electronic calendar, etc.

The user device 540 includes a smart property application 542. The smart property application 542 refers to a software/firmware program running on the corresponding mobile device that enables the user interface and features described throughout. The user device 540 may load or install the smart property application 542 based on data received over a network or data received from local media. The smart property application 542 runs on mobile devices platforms, such as iPhone, iPod touch, Blackberry, Google Android, Windows Mobile, etc. The smart property application 542 enables the user device 540 to receive and process image and sensor data from the monitoring system.

The user device 550 may be a general-purpose computer (e.g., a desktop personal computer, a workstation, or a laptop computer) that is configured to communicate with the monitoring application server 560 and/or the control unit 510 over the network 505. The user device 550 may be configured to display a smart property user interface 552 that is generated by the user device 550 or generated by the monitoring application server 560. For example, the user device 550 may be configured to display a user interface (e.g., a web page) provided by the monitoring application server 560 that enables a user to perceive images captured by the camera 530 and/or reports related to the monitoring system. Although FIG. 5 illustrates two user devices for brevity, actual implementations may include more (and, perhaps, many more) or fewer user devices.

In some implementations, the one or more user devices 540 and 550 communicate with and receive monitoring system data from the control unit 510 using the communication link 538. For instance, the one or more user devices 540 and 550 may communicate with the control unit 510 using various local wireless protocols such as Wi-Fi, Bluetooth, Z-wave, Zigbee, HomePlug (Ethernet over power line), or wired protocols such as Ethernet and USB, to connect the one or more user devices 540 and 550 to local security and automation equipment. The one or more user devices 540 and 550 may connect locally to the monitoring system and its sensors and other devices. The local connection may improve the speed of status and control communications because communicating through the network 505 with a remote server (e.g., the monitoring application server 560) may be significantly slower.

Although the one or more user devices 540 and 550 are shown as communicating with the control unit 510, the one or more user devices 540 and 550 may communicate directly with the sensors and other devices controlled by the control unit 510. In some implementations, the one or more user devices 540 and 550 replace the control unit 510 and perform the functions of the control unit 510 for local monitoring and long range/offsite communication.

In other implementations, the one or more user devices 540 and 550 receive monitoring system data captured by the control unit 510 through the network 505. The one or more user devices 540, 550 may receive the data from the control unit 510 through the network 505 or the monitoring application server 560 may relay data received from the control unit 510 to the one or more user devices 540 and 550 through the network 505. In this regard, the monitoring application server 560 may facilitate communication between the one or more user devices 540 and 550 and the monitoring system.

In some implementations, the one or more user devices 540 and 550 may be configured to switch whether the one or more user devices 540 and 550 communicate with the control unit 510 directly (e.g., through link 538) or through the monitoring application server 560 (e.g., through network 505) based on a location of the one or more user devices 540 and 550. For instance, when the one or more user devices 540 and 550 are located close to the control unit 510 and in range to communicate directly with the control unit 510, the one or more user devices 540 and 550 use direct communication. When the one or more user devices 540 and 550 are located far from the control unit 510 and not in range to communicate directly with the control unit 510, the one or more user devices 540 and 550 use communication through the monitoring application server 560.

Although the one or more user devices 540 and 550 are shown as being connected to the network 505, in some implementations, the one or more user devices 540 and 550 are not connected to the network 505. In these implementations, the one or more user devices 540 and 550 communicate directly with one or more of the monitoring system components and no network (e.g., Internet) connection or reliance on remote servers is needed.

In some implementations, the one or more user devices 540 and 550 are used in conjunction with only local sensors and/or local devices in a house. In these implementations, the system 500 includes the one or more user devices 540 and 550, the sensors 520, the module 522, the camera 530, and the robotic devices, e.g., that can include the drone 590. The one or more user devices 540 and 550 receive data directly from the sensors 520, the module 522, the camera 530, and the robotic devices and send data directly to the sensors 520, the module 522, the camera 530, and the robotic devices. The one or more user devices 540, 550 provide the appropriate interfaces/processing to provide visual surveillance and reporting.

In other implementations, the system 500 further includes network 505 and the sensors 520, the module 522, the camera 530, the thermostat 534, and the robotic devices are configured to communicate sensor and image data to the one or more user devices 540 and 550 over network 505 (e.g., the Internet, cellular network, etc.). In yet another implementation, the sensors 520, the module 522, the camera 530, the thermostat 534, and the robotic devices are intelligent enough to change the communication pathway from a direct local pathway when the one or more user devices 540 and 550 are in close physical proximity to the sensors 520, the module 522, the camera 530, the thermostat 534, and the robotic devices to a pathway over network 505 when the one or more user devices 540 and 550 are farther from the sensors 520, the module 522, the camera 530, the thermostat 534, and the robotic devices. In some examples, the system leverages GPS information from the one or more user devices 540 and 550 to determine whether the one or more user devices 540 and 550 are close enough to the sensors 520, the module 522, the camera 530, the thermostat 534, and the robotic devices to use the direct local pathway or whether the one or more user devices 540 and 550 are far enough from the sensors 520, the module 522, the camera 530, the thermostat 534, and the robotic devices that the pathway over network 505 is required. In other examples, the system leverages status communications (e.g., pinging) between the one or more user devices 540 and 550 and the sensors 520, the module 522, the camera 530, the thermostat 534, and the robotic devices to determine whether communication using the direct local pathway is possible. If communication using the direct local pathway is possible, the one or more user devices 540 and 550 communicate with the sensors 520, the module 522, the camera 530, the thermostat 534, and the robotic devices using the direct local pathway. If communication using the direct local pathway is not possible, the one or more user devices 540 and 550 communicate with the sensors 520, the module 522, the camera 530, the thermostat 534, and the robotic devices using the pathway over network 505.

In some implementations, the system 500 provides end users with access to images captured by the camera 530 to aid in decision-making. The system 500 may transmit the images captured by the camera 530 over a wireless WAN network to the user devices 540 and 550. Because transmission over a wireless WAN network may be relatively expensive, the system 500 can use several techniques to reduce costs while providing access to significant levels of useful visual information (e.g., compressing data, down-sampling data, sending data only over inexpensive LAN connections, or other techniques).

In some implementations, a state of the monitoring system 500 and other events sensed by the monitoring system 500 may be used to enable/disable video/image recording devices (e.g., the camera 530). In these implementations, the camera 530 may be set to capture images on a periodic basis when the alarm system is armed in an “away” state, but set not to capture images when the alarm system is armed in a “stay” state or disarmed. In addition, the camera 530 may be triggered to begin capturing images when the alarm system detects an event, such as an alarm event, a door-opening event for a door that leads to an area within a field of view of the camera 530, or motion in the area within the field of view of the camera 530. In other implementations, the camera 530 may capture images continuously, but the captured images may be stored or transmitted over a network when needed.

The described systems, methods, and techniques may be implemented in digital electronic circuitry, computer hardware, firmware, software, or in combinations of these elements. Apparatus implementing these techniques may include appropriate input and output devices, a computer processor, and a computer program product tangibly embodied in a machine-readable storage device for execution by a programmable processor. A process implementing these techniques may be performed by a programmable processor executing a program of instructions to perform desired functions by operating on input data and generating appropriate output. The techniques may be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language. Suitable processors include, by way of example, both general and special purpose microprocessors. Generally, a processor will receive instructions and data from a read-only memory and/or a random access memory. Storage devices suitable for tangibly embodying computer program instructions and data include all forms of non-volatile memory, including by way of example semiconductor memory devices, such as Erasable Programmable Read-Only Memory (EPROM), Electrically Erasable Programmable Read-Only Memory (EEPROM), and flash memory devices; magnetic disks such as internal hard disks and removable disks; magneto-optical disks; and Compact Disc Read-Only Memory (CD-ROM). Any of the foregoing may be supplemented by, or incorporated in, specially designed ASICs (application-specific integrated circuits).

It will be understood that various modifications may be made. For example, other useful implementations could be achieved if steps of the disclosed techniques were performed in a different order and/or if components in the disclosed systems were combined in a different manner and/or replaced or supplemented by other components. Accordingly, other implementations are within the scope of the disclosure.

1. A system comprising one or more computers and one or more storage devices on which are stored instructions that are operable, when executed by the one or more computers, to cause the one or more computers to perform operations comprising:
maintaining data that represents an image;
providing, to a machine learning model, the data that represents the image;
receiving, from the machine learning model, output data that includes i) an object detection result that indicates whether a target object is detected in the image and ii) an object embedding for the target object; and
determining whether to perform an automated action using the output data.

2. The system of claim 1, wherein receiving the output data comprises receiving the output data from the machine learning model that comprises i) a visual recognition branch that generates the object detection result and ii) an embedding branch that generates the object embedding.

3. The system of claim 2, wherein receiving the output data comprises receiving the output data from the machine learning model that includes the embedding branch that includes a first proper subset of one or more training layers, the one or more training layers having included a) the first proper subset and b) a second proper subset that was not included in the machine learning model for inference.

4. The system of claim 2, wherein receiving the output data comprises receiving the output data from the machine learning model that includes one or more shared initial layers that generate data used by both the visual recognition branch and the embedding branch.

5. The system of claim 4, wherein receiving the output data comprises receiving the output data from the machine learning model that was trained using i) a first loss value for the one or more shared initial layers and the visual recognition branch and ii) a second loss value for the one or more shared initial layers and the embedding branch.

6. The system of claim 1, wherein receiving the output data comprises receiving the output data that includes the object embedding for the target object that was extracted from an image object embedding for the image using location data that indicates a likely location of the target object detected in the image.

7. The system of claim 1 wherein receiving, from the machine learning model, the output data that includes i) an object detection result that indicates whether a target object is detected in the image and ii) an object embedding for the target object comprises:
receiving, from the machine learning model, the output data that includes i) an object detection result that indicates that a target object is detected in the image and location data that indicates a likely location of the target object detected in the image, and ii) an object embedding for the target object.

8. The system of claim 7 wherein the location data comprises a bounding box for the detected target object.

9. The system of claim 1 wherein receiving, from the machine learning model, output data that includes an object detection result that indicates whether a target object is detected in the image comprises:
receiving output data that includes, for the object detection result, an object category; and
receiving, for the object detection result, a likelihood that the detected target object belongs to the object category.

10. The system of claim 1 wherein the object embedding for the target object comprises:
discriminative features of the detected target object, the features containing data elements for differentiating objects that belong to the same category.

11. The system of claim 1 wherein determining whether to perform an automated action using the output data comprising:
providing, to an object matching engine, the i) object detection result that indicates whether a target object is detected in the image and ii) object embedding for the target object; and
receiving, from the object matching engine, data that includes an object matching result indicating whether the detected target object is likely the same as another object detected in another image from a sequence of images that includes the image as part of an object tracking process.

12. A computer-implemented method comprising
maintaining data that represents an image;
providing, to a machine learning model, the data that represents the image;
receiving, from the machine learning model, output data that includes i) an object detection result that indicates whether a target object is detected in the image and ii) an object embedding for the target object; and
determining whether to perform an automated action using the output data.

13. The method of claim 12, wherein receiving the output data comprises receiving the output data from the machine learning model that comprises i) a visual recognition branch that generates the object detection result and ii) an embedding branch that generates the object embedding.

14. The method of claim 13, wherein receiving the output data comprises receiving the output data from the machine learning model that includes the embedding branch that includes a first proper subset of one or more training layers, the one or more training layers having included a) the first proper subset and b) a second proper subset that was not included in the machine learning model for inference.

15. The method of claim 13, wherein receiving the output data comprises receiving the output data from the machine learning model that includes one or more shared initial layers that generate data used by both the visual recognition branch and the embedding branch.

16. The method of claim 14, wherein receiving the output data comprises receiving the output data from the machine learning model that was trained using i) a first loss value for the one or more shared initial layers and the visual recognition branch and ii) a second loss value for the one or more shared initial layers and the embedding branch.

17. The method of claim 12, wherein receiving the output data comprises receiving the output data that includes the object embedding for the target object that was extracted from an image object embedding for the image using location data that indicates a likely location of the target object detected in the image.

18. The method of claim 12 wherein receiving, from the machine learning model, the output data that includes i) an object detection result that indicates whether a target object is detected in the image and ii) an object embedding for the target object comprises:
receiving, from the machine learning model, the output data that includes i) an object detection result that indicates that a target object is detected in the image and location data that indicates a likely location of the target object detected in the image, and ii) an object embedding for the target object.

19. The method of claim 18 wherein the location data comprises a bounding box for the detected target object.

20. One or more non-transitory computer storage media encoded with instructions that, when executed by one or more computers, cause the one or more computers to perform operations comprising:
maintaining data that represents an image;
providing, to a machine learning model, the data that represents the image;
receiving, from the machine learning model, output data that includes i) an object detection result that indicates whether a target object is detected in the image and ii) an object embedding for the target object; and
determining whether to perform an automated action using the output data.
